(19) United States
(12) Patent Application Publication
(10) Pub. No.: US 2023/0370220 A1
(43) Pub. Date: Nov. 16, 2023

(54) METHODS FOR DYNAMIC ALLOCATION OF ONE OR MORE SYNCHRONIZATION SIGNAL BLOCKS, A RELATED NETWORK NODE AND A RELATED WIRELESS DEVICE

(71) Applicant: Sony Group Corporation, Tokyo (JP)

(72) Inventors: Fredrik RUSEK, Eslöv (SE); Jose FLORDELIS, Lund (SE); Kun ZHAO, Malmö (SE); Erik Lennart BENGTSSON, Eslöv (SE); Olof ZANDER, Södra Sandby (SE)

(21) Appl. No.: 18/029,905

(22) PCT Filed: Oct. 6, 2021
(86) PCT No.: PCT/EP2021/077512

§ 371 Date: Apr. 1, 2023

(30) Foreign Application Priority Data
Oct. 16, 2020 (SE) 2051208-3

(51) Int. Cl. H04L 5/00; H04W 16/14; H04L 27/00

(52) U.S. Cl. CPC H04L 5/0048; H04L 5/0092; H04L 27/0006; H04W 16/14

(57) ABSTRACT

A method is disclosed performed by a network node, for dynamic allocation of one or more Synchronization Signal Blocks (SSBs) of a plurality of SSBs, including a first SSB and a second SSB, in an SSB burst transmission to one or more wireless devices. The method comprises transmitting, to the one or more wireless devices, control signaling indicating a first frequency resource for the first SSB and a second frequency resource for the second SSB in the SSB burst transmission. The first frequency resource and the second frequency resource are different.

The present disclosure pertains to the field of wireless communications. The present disclosure relates to methods, for dynamic allocation of one or more Synchronization Signal Blocks (SSBs) of a plurality of SSBs in an SSB burst transmission to one or more wireless devices and related devices, such as a related network node and a related wireless device.

### BACKGROUND

The 3^{rd} Generation Partnership Project (3GPP) is currently discussing New Radio (NR) for unlicensed 52+ GHz bands, such as unlicensed frequency bands above 52 GHz. It is apparent that Synchronization Signal Blocks (SSBs) can play an important role also in unlicensed bands. In order to transmit an SSB burst, it is mandatory from regulatory constraints to perform a Clear Channel Assessment (CCA) procedure, such as a Listen Before Talk (LBT) procedure, for each SSB signal. Only SSB signals for which the CCA is successful may be transmitted.

If the network node (such as a gNB) transmits its SSB burst at a fixed frequency location, problems may arise due to an increase in traffic at said frequency over time, which results in the CCA procedures failing unacceptably often.

### SUMMARY

Accordingly, there is a need for devices and methods for dynamic allocation of one or more SSBs of a plurality of SSBs, which mitigate, alleviate or address the shortcomings existing and provide a more robust SSB transmission.

A method is disclosed, performed by a network node, for dynamic allocation of one or more Synchronization Signal Blocks (SSBs) of a plurality of SSBs, including a first SSB and a second SSB, in an SSB burst transmission to one or more wireless devices. The method comprises transmitting, to the one or more wireless devices, control signaling indicating a first frequency resource for the first SSB and a second frequency resource for the second SSB in the SSB burst transmission. The first frequency resource and the second frequency resource are different.

Further, a network node is provided, the network node comprising circuitry. The circuitry is configured to cause the network node to perform the method disclosed herein.

It is an advantage of the present disclosure that the network node may indicate different frequency resources allocated for at least two SSBs, communicated using respective beams between the network node and one or more wireless devices, of a single SSB burst. Thereby, the network node can dynamically allocate frequency resources for SSB transmissions on the different beams, based on traffic on the respective frequency resources. Allocating at least two SSBs on different frequency resources increases the occupied bandwidth of the transmitted SSBs, which can make the SSB more likely to be detected by other communication systems, such as WiFi, in order to avoid a collision of transmissions. This reduces the likelihood of failed CCA procedures prior to transmitting the SSBs, since the network node may determine to transmit the SSBs on frequency resources having limited traffic. Thereby a more robust SSB transmission is provided.

Further, a method is disclosed, performed by a wireless device, for enabling dynamic allocation of one or more Synchronization Signal Blocks (SSBs) of a plurality of SSBs, including a first SSB and a second SSB, in an SSB burst transmission. The method comprises receiving, from a network node, control signaling indicating a first frequency resource for the first SSB and a second frequency resource for the second SSB in the SSB burst transmission. The first frequency resource and the second frequency resource are different. The method comprises measuring at least one SSB of the plurality of SSBs according to the control signaling received.

Further, a wireless device is provided. The wireless device comprises circuitry, the circuitry being configured to cause the wireless device to perform the method disclosed herein.

It is an advantage of the present disclosure that the wireless device may be informed about the different frequency resources allocated for at least two SSBs of an SSB burst. The wireless device is informed about which frequency resources the wireless device is to use to listen for SSBs. The wireless device may experience fewer failed SSB receptions.

It may be appreciated that SSB bursts may be non-overlapping at the different frequencies and that the time and frequency resources for each beam sweep may be shared with the wireless device according to the disclosed technique. It may be advantageous when beam sweeps are independent from one another, and are continuously present in some examples.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example network node and an example wireless device according to this disclosure,

FIG. 2 is a diagram illustrating an example communication between an example network node and an example wireless device,

FIG. 3 is a flow-chart illustrating an example method, performed by a network node, for dynamic allocation of one or more SSBs of a plurality of SSBs in an SSB burst transmission to one or more wireless devices according to this disclosure,

FIG. 4 is a flow-chart illustrating an example method, performed by a wireless device, for enabling dynamic allocation of one or more SSBs of a plurality of SSBs in an SSB burst according to this disclosure,

FIG. 5 is a block diagram illustrating an example network node according to this disclosure, and

FIG. 6 is a block diagram illustrating an example wireless device according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

In 3GPP NR, a network node, such as a gNB, periodically transmits SSBs for allowing a wireless device to determine a best beam for communication between the wireless device and the network node. A beam may herein be seen as a spatial filter, indicative of a spatial direction. The network node may have a plurality of beams used for communication, such as radiated by the network node, such as Downlink (DL) beams, such as Transmit (Tx) beams, wherein each beam covers a different spatial direction. The network node may transmit multiple SSBs within a certain interval. Each SSB may be identified by a unique number called an SSB Identity (ID). Each SSB may be transmitted by the network node via a specific beam radiated in a certain direction. The wireless device may listen for SSBs and may measure the signal strength of each SSB it detects. Based on the measurement, such as based on a measurement result, the wireless device may identify the SSB ID with the strongest signal strength. The beam of the SSB with the strongest signal strength is declared as the best beam for communicating with the wireless device.

In unlicensed frequency bands and/or in licensed frequency bands shared by a plurality of operators, the network node has to perform an LBT procedure prior to the transmission of any SSB. This may result in some SSBs in certain directions (using certain beams) being prohibited from transmission, since in said directions there may be traffic on the channel. The unlicensed frequency bands, such as frequency band above 52 GHz, such as the 60 GHz band, is typically wide bands. According to one or more example methods herein, the network node may place its SSB burst in any part of the frequency band, such as in a sub-band of the frequency band. The sub-band herein may be seen as a part of the frequency band, such as a finite number of pre-defined adjacent frequency resources within the frequency band. A sub-band may comprise one or more resource elements, RE, which are adjacent within the sub-band. Initially, the wireless device searches for SSBs over the entire frequency band. Once the wireless device has received an initial SSB the wireless device may monitor the sub-band in which the initial SSB is allocated.

Thereby, the wireless device may monitor for SSBs at a finite number of pre-defined frequency locations, wherein each predefined frequency resource is confined to a sub-band. The frequency resources, such as the sub-bands or parts of the sub-bands, may for example be X GHz wide, such as 2 GHz. For a frequency band being Y GHz wide, the frequency band may be split into Y/X frequency resources. For example, for the 60 GHz frequency band, and with a frequency resource width of 2 GHz, the frequency band may be split into 30 frequency resources, such as sub-bands, each being 2 GHz wide. It is however to be appreciated, that other sub-band widths may be allocated. For example, depending on the country, sub-bands being between 7 GHz to 13 GHz have been allocated to the 60 GHz band. Each SSB may for example take up to a few hundred of MHz of the bandwidth. An SSB burst herein may be seen as a transmission of SSBs on one or more frequency resources on a plurality of beams over one or more pre-defined time spans. In order to reduce the risk of SSBs being prohibited due to traffic on the channel, the network node may, according to the current disclosure, perform CCA across a plurality of frequency resources, such as sub-bands of an unlicensed frequency band, using the plurality of beams, in multiple beam directions.

In each beam-direction, the network node may transmit its corresponding SSB at the frequency resource, e.g., sub-band, with the least amount of traffic. The network node further transmits control signaling to one or more, such as some or all, connected wireless devices, indicating the respective resources, such as frequency resources and/or time resources, such as time slots, in which the one or more wireless devices can find at least two SSBs of the SSB burst.

The figures are schematic and simplified for clarity, and they merely show details which aid understanding the disclosure, while other details have been left out. Throughout, the same reference numerals are used for identical or corresponding parts.

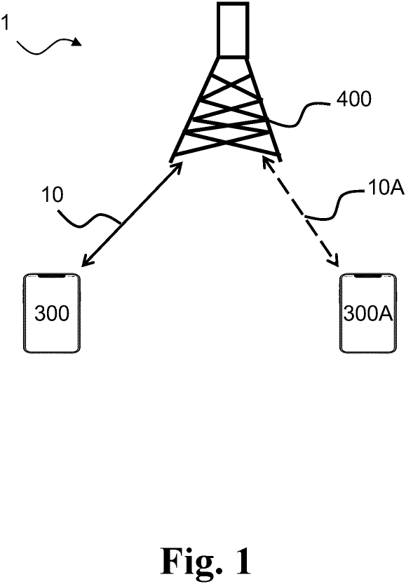

FIG. 1 is a diagram illustrating an example wireless communication system 1 comprising an example network node 400 and an example wireless device 300 according to this disclosure.

As discussed in detail herein, the present disclosure relates to a wireless communication system 1 comprising a cellular system, for example, a 3GPP wireless communication system. The wireless communication system 1 comprises a wireless device 300 and/or a network node 400.

A network node disclosed herein refers to a radio access network node operating in the radio access network, such as a base station, an evolved Node B, eNB, and/or gNB in NR. In one or more examples, the network node is a functional unit which may be distributed in several physical units.

The wireless communication system 1 described herein may comprise one or more wireless devices 300, 300A, and/or one or more network nodes 400, such as one or more of: a base station, an eNB, a gNB and/or an access point.

A wireless device may refer to a mobile device and/or a user equipment (UE).

The wireless device 300, 300A may be configured to communicate with the network node 400 via a wireless link (or radio access link) 10, 10A.

In some example wireless communications systems according to the disclosure, the network node, such as the gNB, may have K SSBs to transmit in an SSB burst. In some example wireless communication systems, the network node may have 64 SSBs to transmit, which may be transmitted in any direction (such as all in the same direction, all in different directions, some in the same direction and/or some in different directions) and at any frequency resource (such as all in the same frequency resource and/or some in the same frequency resource and some in different frequency resources and/or all in different frequency resources). There may be a raster of N frequency resources, such as sub-bands of a frequency band, in which the K SSBs could potentially be transmitted. The frequency spectrum may also be referred to as a frequency band. A 1×K index-vector,

$$I = \left[\begin{matrix}{i}_{1} & {i}_{2} & ⋯ & {i}_{K}\end{matrix}\right] \qquad \text{(1)}$$

where 1 ≤ iₖ ≤ N for 1 ≤ k ≤ K, may be defined, such as by the network node. In other words, the kth entry of I indicates in which frequency resource, such as sub-band, the kth SSB is currently being transmitted. The network node may transmit relevant parts of the index-vector I to one or more connected wireless devices. In one or more example methods, the whole index-vector may be relevant for the one or more connected wireless devices and the whole index vector may thus be transmitted to the one or more connected wireless devices.

In previously known licensed bands the frequency resources would be the same for all SSBs, such that i₁ = i₂ = ... = i_{K}. Each SSB would be transmitted in a unique direction.

According to one or more examples disclosed herein, the network node, such as the gNB, may perform LBT, such as a clear channel assessment, for a beam k at frequency resources, such as sub-bands, Y different from iₖ. The search set Y may be an arbitrary subset of {1, 2, ..., N}.

The frequency resources Y may be chosen in different ways. In one or more example methods, if the network node observes that for beam k there is very little traffic on sub-band iₖ, there may be no reason for the network node to search for another sub-band for this beam. In one or more example methods, the network node may however search for a backup band for beam k, in case the channel conditions would get worse. With that said, there are multiple strategies for choosing the frequency resources, and it may be up to implementation.

In one or more example methods, the network node may determine different frequency resources to perform LBT for the different beams.

In one or more example methods, the network node may perform several LBT procedures at different frequency resources, such as sub-bands, and/or directions simultaneously.

According to one or more examples disclosed herein, various of the K SSBs may be sent in the same direction. This may for example be done, by sending the K SSBs on different frequency resources, simultaneously. This may reduce the search time for a wireless device, since the best beam from the perspective of the wireless device can then be found at several frequency resources, such as frequency sub-bands.

Assume that the network node, such as the gNB, has CCA information at frequency resources, such as sub-bands, different from i₁, and that the network node may observe high traffic at frequency resource i₁, but much less traffic at some other frequency resource, say i′ for a beam. In one or more example methods disclosed herein, the network node may switch the SSB transmission from frequency resource i₁ to i′ and may inform all connected wireless devices about the switch. This information may be transmitted to a set of wireless devices that may possibly be affected by the switch and/or may be broadcasted. The information may e.g. be broadcasted as a part of system information. This example is described for one beam transmitted on frequency resource i₁;, the solution however applies verbatim to all other beams.

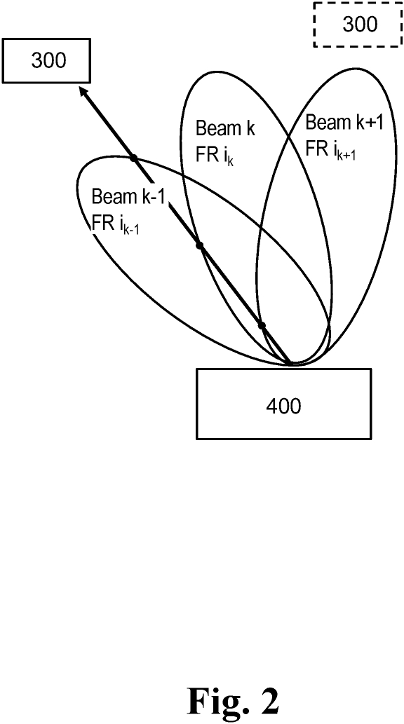

For unconnected wireless devices, the network node does not need to inform them about a switch, since the wireless device does not know where to search for the SSB and automatically scans all predefined frequency resources. However, there are problems with this approach which will be described in relation to FIG. 2.

FIG. 2 shows an example scenario in which the method disclosed herein may be applied. In the example scenario shown in FIG. 2 the wireless device 300 may be engaged in an initial access procedure with the network node 400. The network node 400 may have transmitted SSBs on the beams k-1, k and k+1. The wireless device may just have transmitted a Physical Random Access Channel (PRACH) preamble in response to a received SSB transmission from the network node 400. The wireless device may transmit the PRACH response to a beam corresponding to the SSB on which the wireless device measured a highest channel quality. The wireless device 300 may be located at a position relative to the network node 400 as indicated by the solid-lined box. The beam strengths as seen by the wireless device are indicated in FIG. 2 with the line thickness of the beams, where a thicker line indicates a stronger beam. In other words, in the example shown in FIG. 2 beam k-1 is stronger than beam k, which in turn is stronger than beam k+1.

It may be appreciated that in an example scenario, the wireless device is in an unconnected state and performs an initial access procedure to establish a connection with the network node. The wireless device may be configured to scan for SSBs on a set of predefined frequency resources during the initial access procedure. For example, SSBs on beam k and k+1 may be transmitted on the predefined frequency resources and SSBs of beam k-1 may be transmitted on a frequency resource other than the set of predefined frequency resources. It may be appreciated that the wireless device 300 has transmitted a PRACH message, such as a PRACH preamble to beam k, such as a PRACH preamble indicating that beam k is the best beam, such as the strongest beam, as seen by the wireless device when listening to and measuring SSBs on the predefined frequency resources. Beam k may thus initially be the best beam known to the wireless device 300.

The best beam herein may be seen as the beam having the best channel quality, such as signal strength, detected by the wireless device when measuring on the SSBs associated with, such as transmitted on, the beams. From FIG. 2, it can be seen, however, that beam k-1 may in fact be the best beam as seen by the wireless device. From the PRACH response, the network node, such as the gNB, has a rough estimate of the spatial direction to the wireless device, but it cannot distinguish the actual location of the wireless device from a different possible location, such as the possible location of the wireless device as indicated by the dotted box 300. It would be a system benefit if the wireless device could listen to beams k-1 and k+1 as well, to possibly find a better beam than beam k.

When, for example, beams k and k+1 are transmitted at the same frequency resource (FR), such as when FR iₖ= FR iₖ₊₁, the wireless device can be assumed to have heard (and responded to) beam k+1 if beam k+1 was indeed a better beam than beam k. In one or more example methods disclosed herein, the network node may indicate to the wireless device that the wireless device should search for SSBs at frequency resource FR iₖ₋₁ as well. The network node 400 may thus inform the wireless device 300 about the frequency resources in which the wireless device 300 is to listen for SSBs. The network node 400 may e.g. inform the wireless device about the frequency resources used for transmitting SSBs for one or more beams, such as one or more associated beams, such as one or more neighboring beams to the beam k. The network node 400 may inform the wireless device of the frequency resource, by transmitting control signaling to the wireless device 300 indicating the frequency resources on which SSBs are transmitted for the one or more beams. In one or more example methods, the network node may provide the wireless device with an exact time resource, such as a time-slot, which may be the same or different than the time resource for beam k, in which the SSBs are transmitted on beam k-1. In other words, according to the one or more example methods disclosed herein, a wireless device attempting an initial access will not settle with the first frequency resource containing a beam having a good-enough strength, but will receive an indication from the network node 400 to scan other frequency resources, such as sub-bands which may potentially contain a better beam. A full scan of all the sub-bands by the wireless device is thus avoided while increasing the chance to find an optimal beam for communication, such as for communication between the wireless device 300 and the network node 400. In some example methods disclosed herein, the network node may change the time upon changing the frequency resource of the SSBs transmitted on a beam.

In licensed bands, both the SSB configuration (time resources and total number of SSBs) and the current SSB ID are broadcasted in each SSB or specified by the standard. According to one or more example methods disclosed herein, the SSB configuration may be enhanced with a frequency allocation of the SSBs. The SSB configuration may thus comprise the time, the total number, the SSB ID and the frequency allocation, such as the frequency resource, of the SSBs.

In some example scenarios, the wireless device may, based solely on the beam characteristics of the beam k, very well be located at the spot indicated by the dashed box 300 in FIG. 2. In one or more example methods disclosed herein, the network node may indicate, to the wireless device 300, the resources, such as time resources, such as timeslots, and/or frequency resources, such as the frequency resources FR iₖ₋₁ and FR iₖ₊₁, where the network node wants the wireless device to listen for SSBs. The network node may indicate the time resources in which the SSBs are transmitted for each frequency resource to the wireless device.

In one or more example methods disclosed herein, the wireless device may send a PRACH message, such as a PRACH preamble to the wireless node in response to a first (legacy) SSB burst, in which all SSBs are transmitted on the same frequency resource. After the wireless device has transmitted the PRACH preamble, the network node may change frequency resource for transmitting SSBs on one or more beams, based on a clear channel assessment performed by the network node on one or more frequency resources of the one or more beams. The network node may transmit control signaling to the wireless device indicating the changed frequency resources. The network node may further indicate, such as in the control signaling, to the wireless device that it is to listen for SSBs on the changed frequency resources. The indication that the wireless device is to listen for SSBs on the changed frequency resources, may be an explicit indication to listen for SSBs on the indicated frequency resources, such as by a dedicated bit in the control signaling, or may be implicitly indicated by transmitting the changed frequency resources. The wireless device may thereafter measure on the indicated frequency resources and may send another PRACH preamble for the best beam based on the measurement on the changed frequency resources. The best beam, as seen by the wireless device, may change or may remain the same.

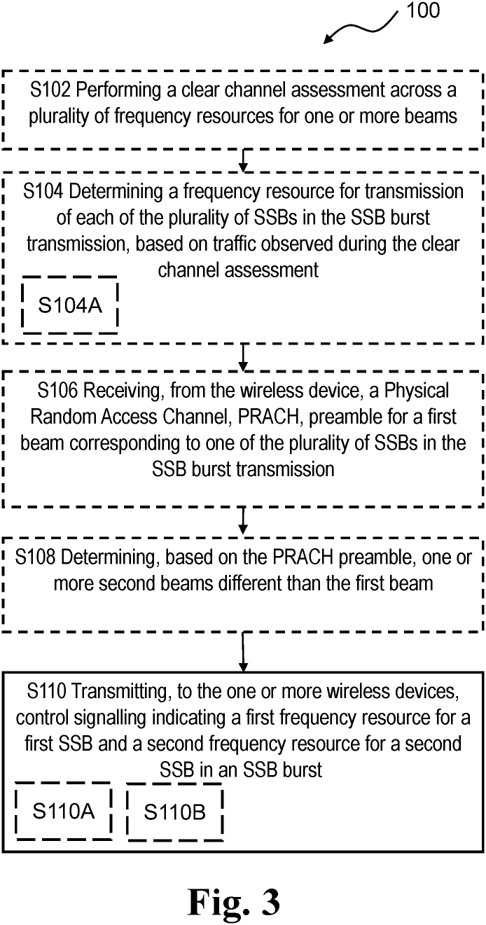

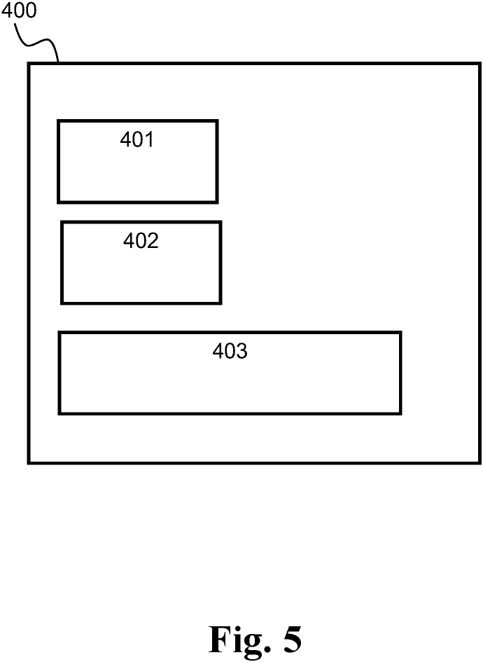

FIG. 3 shows a flow diagram of an example method 100, performed by a network node, for dynamic allocation of the one or more SSBs of the plurality of SSBs in the SSB burst transmission to one or more wireless devices, according to the disclosure. The network node is the network node disclosed herein, such as network node 400 of FIG. 1, FIG. 2, and FIG. 5. The one or more SSBs include a first SSB and a second SSB. The SSB burst is communicated using a plurality of beams of the network node, for example associating one SSB per beam.

The method 100 comprises transmitting S110, to the one or more wireless devices, control signaling indicating a first frequency resource for the first SSB and a second frequency resource for the second SSB in the SSB burst transmission. The first frequency resource and the second frequency resource are different.

In one or more example methods, the control signaling may be indicative of a respective frequency resource for each SSB in the SSB burst transmission. The network node may allocate a respective frequency resource for each SSB of the SSB burst. In other words, there may be a respective frequency resource associated with each SSB of the SSB burst. At least one of the respective frequency resources is different from the others. For example, the SSB burst may comprise a third SSB, a fourth SSB, and a fifth SSB, and the network node allocates a third frequency resource to the third SSB, and a fourth frequency resource to the fourth SSB, and a fifth frequency resource to the fifth SSB. For example, the first frequency resource, the second frequency resource, the third frequency resource, the fourth frequency resource and the fifth frequency resource are different from one another. In one or more examples, at least one of the first frequency resource, the second frequency resource, the third frequency resource, the fourth frequency resource and the fifth frequency resource is different than the other and the remaining frequency resources may be the same. In one or more example methods, the control signaling is indicative of a plurality of respective frequency resources for each of the plurality of SSBs in the SSB burst transmitted by the network node. The control signaling may thus comprise the complete index-vector I described in Equation (1), such as all entries of the index-vector I.

In one or more example methods, the network node may transmit SSBs on multiple frequency resources using the same beam in a same SSB burst. The network node may indicate to the wireless device that it should listen for SSBs in a plurality of frequency resources using one or more beams of the same SSB burst. The network node may allocate a plurality of frequency resources on each beam for transmission of SSBs.

In one or more example methods, the control signaling may be indicative of a respective time resource for each SSB of the plurality of SSBs in the SSB burst transmission. The control signaling may indicate the resource(s), such as the time resource and frequency resource, for one or more SSBs of the SSB burst, such as for one or more beams of the network node.

The frequency resource(s) may be part of an unlicensed frequency band or of a licensed frequency band being shared by a plurality of operators. The one or more SSBs of the SSB burst may thus be allocated in the unlicensed frequency band or in the licensed frequency band being shared by the plurality of operators.

In one or more example methods, the frequency resource may be a sub-band of the unlicensed frequency band or the licensed frequency band being shared by a plurality of operators. A sub-band herein may be seen as a sub-part of the frequency band, such as a finite number of pre-defined frequency resources within the frequency band, such as having a narrower frequency than the frequency band. Each predefined frequency resource may occupy a resource space which is less than the frequency band.

In one or more example methods, the method 100 comprises performing S102 a clear channel assessment across a plurality of frequency resources for one or more beams. The network node may perform the clear channel assessment (such as LBT) to determine how much traffic there is on the plurality of frequency resources for the one or more beams.

In one or more example methods, the method 100 comprises determining S104 a frequency resource for transmission of each of the plurality of SSBs in the SSB burst transmission, based on traffic observed during the clear channel assessment. In one or more example methods, determining S104 the frequency resource comprises determining S104A to transmit each SSB of the plurality of SSBs in the respective frequency resource showing the least amount of traffic for each SSB of the plurality of SSBs. In other words, the network node may allocate the SSBs in the respective frequency resources showing the least amount of traffic for each beam of the wireless device. The frequency resource showing the least amount of traffic may be the frequency resources where the energy level detected by the network node is the lowest, such as below an energy level threshold. For example, in the unlicensed 60 GHz frequency band, the threshold may be -47 dBm for 40 dBm of radiated power. Upon determining that a frequency resource other than (such as different than) the frequency resource which the SSBs are currently transmitted on has less traffic than the frequency resource which the SSBs are currently transmitted on, the network node may change the frequency resource to which the SSBs are allocated. In one or more examples, the network node may allocate SSBs in a plurality of frequency resources on one or more of its beams. In other words, one or more of the beams may each have SSBs allocated in a plurality of frequency resources. The network node may thus transmit SSBs on a plurality of different frequency resources for each beam during transmission of an SSB burst.

The control signaling may be transmitted by the network node when the frequency resource of at least one SSB of the plurality of SSBs of the SSB burst changes, such as when the network node changes frequency allocation of one or more SSBs of the SSB burst.

In one or more example methods, the method 100 comprises receiving S106, from the wireless device, a Physical Random Access Channel, PRACH, message (such as PRACH preamble) for a first beam corresponding to one of the plurality of SSBs in the SSB burst transmission. The PRACH message, such as the PRACH preamble, may indicate the best beam seen, such as measured, by the wireless device. For example, the best beam may be indicated by a beam ID comprised in the PRACH preamble or by a positional scheme which depends on the PRACH occasion selected by the wireless device to transmit the RACH preamble.

In one or more example methods, the method 100 comprises determining S108, based on the PRACH preamble, one or more second beams different than the first beam. The wireless device may identify the best beam based on the indication in the PRACH preamble, such as based on the beam identifier (ID). Based on the identified beam, the network node may determine one or more beams associated with the best beam identified by the wireless device, such as one or more beams neighboring the best beam identified by the wireless device. The one or more second beams may be beams that may provide a better beam strength and/or channel quality to the wireless device than the first beam identified by the wireless device.

In one or more example methods, transmitting S110 comprises transmitting S110A to the wireless device, control signaling indicative of one or more frequency resources for the one or more second beams to be measured by the wireless device. The control signaling may indicate the respective frequency resources in which the SSBs are transmitted for the one or more second beams in

In one or more example methods, the control signaling may be comprised in a system information message. The control signaling may be included in a system information block, such as SIB1.

In one or more example methods, the control signaling is comprised in an SSB transmission, such as in an SSB.

In one or more example methods, the control signaling is comprised in an SSB configuration. The SSB configuration (time resources and total number of SSBs) and the current SSB ID may be broadcasted in each SSB, such as in the SSB transmission, or may be specified by the standard.

In one or more example methods, transmitting S110 comprises broadcasting S110B the control signaling indicating the first frequency resource and the second frequency resource.

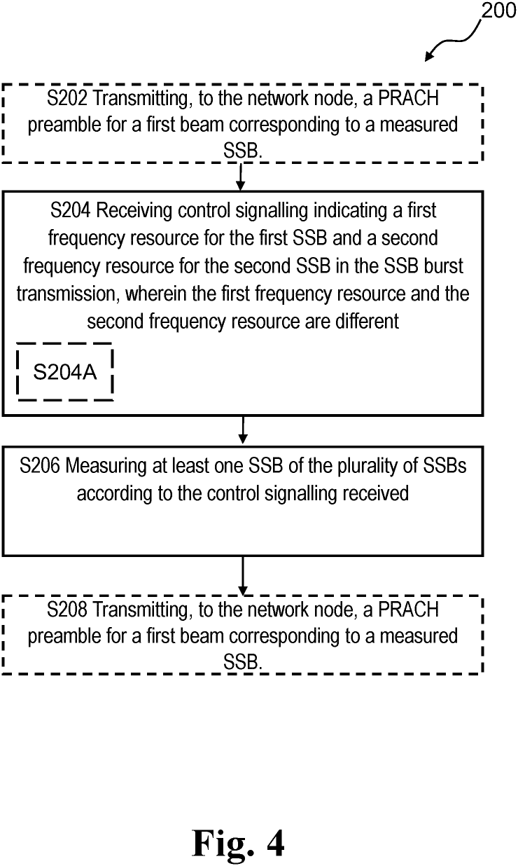

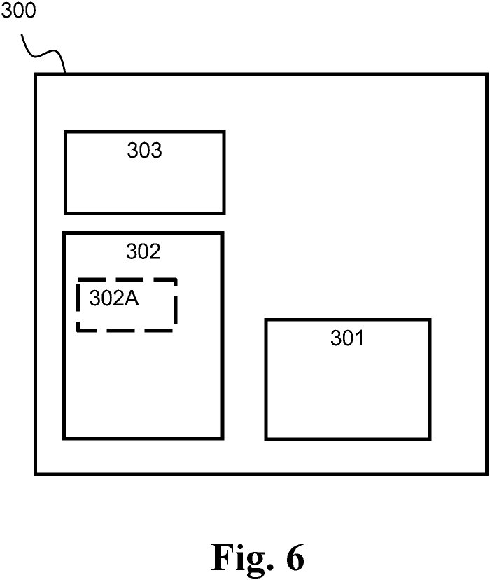

FIG. 4 shows a flow diagram of an example method 200 performed by a wireless device according to the disclosure (such as wireless device 300 of FIG. 1, FIG. 2, and FIG. 6), for enabling dynamic allocation of one or more SSBs of a plurality of SSBs, including a first SSB and a second SSB, in an SSB burst received from a network node. The SSB burst is received using a plurality of beams of the wireless device, for example one SSB reception per beam of the wireless device. The method 200 may be for utilizing dynamic allocation of one or more SSBs of a plurality of SSBs of an SSB burst. The plurality of SSBs includes a first SSB and a second SSB. In other words, the SSB burst includes a plurality of SSBs, which comprises a first SSB and a second SSB.

The method 200 comprises receiving S204, from a network node, control signaling indicating a first frequency resource for the first SSB and a second frequency resource for the second SSB in the SSB burst received from the network node, wherein the first frequency resource and the second frequency resource are different.

In one or more example methods, the wireless device may receive the control signaling indicating the first and the second frequency resource when a frequency allocation of one or more of the SSBs changes, such as when the network node changes frequency allocation of one or more SSBs. In one or more example methods the first frequency resource may indicate a common frequency resource for a plurality of SSBs and the second frequency resource may indicate a different frequency resource for one or more SSBs that have been allocated in a different frequency resource than the first frequency resource. The control signaling may thus comprise only some of the entries of the index-vector I described in Equation (1), that are being considered relevant to the one or more wireless devices.

The method 200 comprises measuring S206 at least one SSB of the plurality of SSBs according to the control signaling received. For example, the wireless device may monitor the indicated first frequency resource and the indicated second frequency resource. The wireless device may measure on the respective SSBs of the first frequency resource and the second frequency resource using corresponding beams, such as wireless device beams, such as receive beams, which may also be referred to as Rx beams. Based on the measurement of the at least one SSBs, such as on the respective SSBs of the first frequency resource and the second frequency resource, the wireless device may determine the best beam as seen by the wireless device for communication between the wireless device and the network node.

In one or more example methods, the control signaling is indicative of a respective frequency resource for each of the plurality of SSBs in the SSB burst received from the network node. At least one of the respective frequency resources is different from the others. For example, the SSB burst may comprise a third SSB, a fourth SSB, and a fifth SSB, etc. The network node may allocate a third frequency resource to the third SSB, a fourth frequency resource to the fourth SSB, and a fifth frequency resource to the fifth SSB. In one or more examples, the first frequency resource, the second frequency resource, the third frequency resource, the fourth frequency resource and the fifth frequency resource are different from one another. In one or more examples, at least one of the first frequency resource, the second frequency resource, the third frequency resource, the fourth frequency resource and the fifth frequency resource is different than the other and the remaining frequency resources may be the same. In one or more example methods, the control signaling is indicative of a plurality of respective frequency resources for each of the plurality of SSBs in the SSB burst received from the network node. The control signaling may thus comprise the complete index-vector I described above, such as all entries of the index-vector I.

In one or more example methods, the control signaling is indicative of a respective time resource for each SSB of the plurality of SSBs in the SSB burst received from the network node. The control signaling may indicate the resource(s), such as the time resource and frequency resource, for one or more SSBs of the SSB burst received from the network node, such as received via one or more beams of the network node.

In one or more example methods, the frequency resource is part of an unlicensed frequency band or of a licensed frequency band being shared by a plurality of operators. The one or more SSBs of the SSB burst may thus be allocated in the unlicensed frequency band or in the licensed frequency band being shared by the plurality of operators.

In one or more example methods, the frequency resource may be a sub-band of the unlicensed frequency band or the licensed frequency band being shared by a plurality of operators. The sub-band herein may be seen as a sub-part of the frequency band, such as a finite number of pre-defined frequency resources within the frequency band, wherein each predefined frequency resource occupies a resource space which is less than the frequency band.

In one or more example methods, the method 200 comprises, transmitting S202, to the network node, a PRACH message (such as a PRACH preamble) for a first beam corresponding to one of the measured SSBs. The wireless device may have measured SSBs transmitted by the network node over one or more beams and may have determined a first beam having the best channel quality, such as signal strength and may indicate the first beam in the PRACH preamble. The network node may previously have been transmitting all SSBs and the wireless device may have measured all SSBs on the same frequency resource. In the meantime, however, the network node may have changed the frequency resource allocation for one or more SSBs in one or more second beams associated with the first beam, such as neighboring the first beam. The one or more second beams may thus be a better beam for the wireless device.

In one or more example methods, receiving S204 may comprise receiving S204A, from the network node, control signaling indicative of one or more frequency resources for one or more second beams different than the first beam, for example, one or more second beams neighboring the first beam. The indicated frequency resource for the one or more second beams is different than the frequency resource used for the SSB of the first beam. The wireless device may thus monitor, such as listen for and measure on, the SSBs allocated in the frequency resources for the one or more second beams, to determine if these SSBs provide a better channel quality than the beam reported in the PRACH preamble.

In one or more example methods disclosed herein, the wireless device may transmit S208, to the network node, a Physical Random Access Channel, PRACH, preamble for the best beam based on the measurement performed on the one or more frequency resources for the one or more second beams different than the first beam.

In one or more example methods, the control signaling is comprised in a system information message. The control signaling may be included in a system information block, such as SIB1.

In one or more example methods, the control signaling is comprised in an SSB transmission, such as in a transmitted SSB.

In one or more example methods, the control signaling is comprised in an SSB configuration. The SSB configuration (time resources and total number of SSBs) and the current SSB ID may be broadcasted in each SSB, such as in the SSB transmission, or may be specified by the standard.

FIG. 5 shows a block diagram of an example network node 400 according to the disclosure. The network node 400 comprises memory circuitry 401, processor circuitry 402, and a wireless interface 403. The network node 400 may be configured to perform any of the methods disclosed in FIG. 2. In other words, the network node 400 may be configured for dynamic allocation of one or more SSBs of a plurality of SSBs, including a first SSB and a second SSB, in an SSB burst transmission to one or more wireless devices.

The network node 400 is configured to communicate with a wireless device, such as the wireless device 300 disclosed herein, using a wireless communication system.

The wireless interface 403 is configured for wireless communications via a wireless communication system, such as a 3GPP system, such as a 3GPP system supporting millimeter-wave communications, such as millimeter-wave communications in licensed bands, such as device-to-device millimeter-wave communications in licensed bands.

The network node 400 is configured to transmit, for example, via the wireless interface 403, to the one or more wireless devices, control signaling indicating a first frequency resource for the first SSB and a second frequency resource for the second SSB in the SSB burst transmission. The first frequency resource and the second frequency resource are different.

Processor circuitry 402 is optionally configured to perform any of the operations disclosed in FIG. 3 (such as any one or more of S102, S104, S104A, S106, S108, S110A, S110B). The operations of the network node 400 may be embodied in the form of executable logic routines (for example, lines of code, software programs, etc.) that are stored on a non-transitory computer readable medium (for example, memory circuitry 401) and are executed by processor circuitry 402.

Furthermore, the operations of the network node 400 may be considered a method that the network node 400 is configured to carry out. Also, while the described functions and operations may be implemented in software, such functionality may as well be carried out via dedicated hardware or firmware, or some combination of hardware, firmware and/or software.

Memory circuitry 401 may be one or more of a buffer, a flash memory, a hard drive, a removable media, a volatile memory, a non-volatile memory, a random access memory (RAM), or other suitable device. In a typical arrangement, memory circuitry 401 may include a non-volatile memory for long term data storage and a volatile memory that functions as system memory for processor circuitry 402. Memory circuitry 401 may exchange data with processor circuitry 402 over a data bus. Control lines and an address bus between memory circuitry 401 and processor circuitry 402 also may be present (not shown in FIG. 4). Memory circuitry 401 is considered a non-transitory computer readable medium.

Memory circuitry 401 may be configured to store information, such as beam information, SSB configurations, such as frequency resources, time resources and identities of the SSBs, in a part of the memory.

FIG. 6 shows a block diagram of an example wireless device 300 according to the disclosure. The wireless device 300 comprises memory circuitry 301, processor circuitry 302, and a wireless interface 303. The processor circuitry 302 may comprise measuring circuitry 302A. The wireless device 300 may be configured to perform any of the methods disclosed in FIG. 4. In other words, the wireless device 300 may be configured for enabling dynamic allocation of one or more SSBs of a plurality of SSBs, including a first SSB and a second SSB, in an SSB burst transmission.

The wireless device 300 is configured to communicate with a network node, such as the network node 400 disclosed herein, using a wireless communication system.

The wireless device 300 is configured to receive (such as via the wireless interface 303), from a network node, control signaling indicating a first frequency resource for the first SSB and a second frequency resource for the second SSB in the SSB burst transmission. The first frequency resource and the second frequency resource are different.

The wireless device 300 is configured to measure (such as via the processor circuitry 302 and/or the measuring circuitry 302A) at least one SSB of the plurality of SSBs according to the control signaling received.

The wireless interface 303 is configured for wireless communications via a wireless communication system, such as a 3GPP system, such as a 3GPP system supporting mm-wave communication.

The wireless device 300 is optionally configured to perform any of the operations disclosed in FIG. 4 (such as any one or more of S202, S204A, S208). The operations of the wireless device 300 may be embodied in the form of executable logic routines (for example, lines of code, software programs, etc.) that are stored on a non-transitory computer readable medium (for example, on the memory circuitry 301) and are executed by processor circuitry 302.

Furthermore, the operations of the wireless device 300 may be considered a method that the wireless device 300 is configured to carry out. Also, while the described functions and operations may be implemented in software, such functionality may as well be carried out via dedicated hardware or firmware, or some combination of hardware, firmware and/or software.

Memory circuitry 301 may be one or more of a buffer, a flash memory, a hard drive, a removable media, a volatile memory, a non-volatile memory, a random access memory (RAM), or other suitable device. In a typical arrangement, memory circuitry 301 may include a non-volatile memory for long term data storage and a volatile memory that functions as system memory for processor circuitry 302. Memory circuitry 301 may exchange data with processor circuitry 302 over a data bus. Control lines and an address bus between memory circuitry 301 and processor circuitry 302 also may be present (not shown in FIG. 6). Memory circuitry 301 is considered a non-transitory computer readable medium.

Memory circuitry 301 may be configured to store information (such as information indicative of second set of paging resources) in a part of the memory.

Examples of methods and products (network node and wireless device) according to the disclosure are set out in the following items:

Item 1. A method, performed by the network node, for dynamic allocation of one or more Synchronization Signal Blocks, SSBs, of a plurality of SSBs, including a first SSB and a second SSB, in an SSB burst transmission to one or more wireless devices, the method comprising:
transmitting (S110), to the one or more wireless devices, control signaling indicating a first frequency resource for the first SSB and a second frequency resource for the second SSB in the SSB burst transmission, wherein the first frequency resource and the second frequency resource are different.

Item 2. The method according to Item 1, wherein the control signaling is indicative of a respective frequency resource for each SSB in the SSB burst transmission.

Item 3. The method according to any one of the previous Items, wherein the control signaling is indicative of a respective time resource for each SSB of the plurality of SSBs in the SSB burst transmission.

Item 4. The method according to any one of the previous Items, wherein the frequency resource is part of an unlicensed frequency band or of a licensed frequency band being shared by a plurality of operators.

Item 5. The method according to Item 4, wherein the frequency resource is a sub-band or part of a sub-band of the unlicensed frequency band or the licensed frequency band being shared by a plurality of operators.

Item 6. The method according to any one of the previous Items, wherein the method comprises:
performing (S102) a clear channel assessment across a plurality of frequency resources for one or more beams, and
determining (S104) a frequency resource for transmission of each of the plurality of SSBs in the SSB burst transmission, based on traffic observed during the clear channel assessment.

Item 7. The method according to Item 6, wherein determining (S104) the frequency resource comprises determining (S104A) to transmit each SSB of the plurality of SSBs in the respective frequency resource showing the least amount of traffic for each SSB of the plurality of SSBs.

Item 8. The method according to any one of the previous Items, wherein the method comprises:
receiving (S106), from the wireless device, a Physical Random Access Channel, PRACH, preamble for a first beam corresponding to one of the plurality of SSBs in the SSB burst transmission.

Item 9. The method according to Item 8, wherein the method comprises:
determining (S108), based on the PRACH preamble, one or more second beams different than the first beam.

Item 10. The method according to any one of the previous claims, wherein transmitting (S110) comprises transmitting (S110A) to the wireless device, control signaling indicative of one or more frequency resources for the one or more second beams to be measured by the wireless device.

Item 11. The method according to any one of the previous Items, wherein the control signaling is comprised in a system information message.

Item 12. The method according to any one of the previous Items, wherein the control signaling is comprised in an SSB transmission.

Item 13. The method according to any one of the previous Items, wherein the control signaling is comprised in an SSB configuration.

Item 14. The method according to any one of the previous Items, wherein transmitting (S110) comprises broadcasting (S110B) the control signaling indicating the first frequency resource and the second frequency resource.

Item 15. A method, performed by a wireless device, for enabling dynamic allocation of one or more Synchronization Signal Blocks, SSBs, of a plurality of SSBs, including a first SSB and a second SSB, in an SSB burst received from a network node, the method comprising:
receiving (S204), from a network node, control signaling indicating a first frequency resource for the first SSB and a second frequency resource for the second SSB in the SSB burst received from the network node, wherein the first frequency resource and the second frequency resource are different; and
measuring (S206) at least one SSB of the plurality of SSBs according to the control signaling received.

Item 16. The method according to Item 15, wherein the control signaling is indicative of a respective frequency resource for each of the plurality of SSBs in the SSB burst received from the network node.

Item 17. The method according to Item 15 or 16, wherein the control signaling is indicative of a respective time resource for each SSB of the plurality of SSBs in the SSB burst received from the network node.

Item 18. The method according to any one of the previous Items 15 to 17, wherein the frequency resource is part of an unlicensed frequency band or of a licensed frequency band being shared by a plurality of operators.

Item 19. The method according to Item 18, wherein the frequency resource is a sub-band of the unlicensed frequency band or the licensed frequency band being shared by a plurality of operators.

Item 20. The method according to any one of the previous Items 15 to 19, wherein the method comprises, transmitting (S202), to the network node, a Physical Random Access Channel, PRACH, preamble for a first beam corresponding to one of the measured SSBs.

Item 21. The method according to Item 20, wherein receiving (S204) comprises receiving (S204A), from the network node, control signaling indicative of one or more frequency resources for one or more second beams different than the first beam, wherein the indicated frequency resource is different than the frequency resource used for the SSB of the first beam.

Item 22. The method according to any one of the previous Items 15 to 21, wherein the control signaling is comprised in a system information message.

Item 23. The method according to any one of the previous Items 15 to 22, wherein the control signaling is comprised in an SSB transmission.

Item 24. The method according to any one of the previous Items 15 to 23, wherein the control signaling is comprised an SSB configuration.

Item 25. A network node comprising circuitry, wherein the circuitry is configured to cause the network node to perform any of the methods according to any of Items 1-14.

Item 26. A wireless device comprising a comprising circuitry, wherein the circuitry is configured to cause the wireless device to perform any of the methods according to any of Items 15-24.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-6 comprises some circuitries or operations which are illustrated with a solid line and some circuitries or operations which are illustrated with a dashed line. Circuitries or operations which are comprised in a solid line are circuitries or operations which are comprised in the broadest example. Circuitries or operations which are comprised in a dashed line are examples which may be comprised in, or a part of, or are further circuitries or operations which may be taken in addition to circuitries or operations of the solid line examples. It should be appreciated that these operations need not be performed in order presented. Furthermore, it should be appreciated that not all of the operations need to be performed. The example operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed by the network node, for dynamic allocation of one or more Synchronization Signal Blocks (SSBs) of a plurality of SSBs, including a first SSB and a second SSB, in an SSB burst transmission to one or more wireless devices, the method comprising: transmitting, to the one or more wireless devices, control signaling indicating a first frequency resource for the first SSB and a second frequency resource for the second SSB in the SSB burst transmission, wherein the first frequency resource and the second frequency resource are different.

2. The method according to claim 1, wherein the control signaling is indicative of a respective frequency resource for each SSB in the SSB burst transmission.

3. The method according to claim 1, wherein the control signaling is indicative of a respective time resource for each SSB of the plurality of SSBs in the SSB burst transmission.

4. The method according to claim 1, wherein the frequency resource is part of an unlicensed frequency band or of a licensed frequency band being shared by a plurality of operators.

5. The method according to claim 4, wherein the frequency resource is a sub-band or part of a sub-band of the unlicensed frequency band or the licensed frequency band being shared by a plurality of operators.

6. The method according to claim 1, wherein the method comprises: performing a clear channel assessment across a plurality of frequency resources for one or more beams, and determining a frequency resource for transmission of each of the plurality of SSBs in the SSB burst transmission, based on traffic observed during the clear channel assessment.

7. The method according to claim 6, wherein determining the frequency resource comprises determining to transmit each SSB of the plurality of SSBs in the respective frequency resource showing the least amount of traffic for each SSB of the plurality of SSBs.

8. The method according to claim 1, wherein the method comprises: receiving, from the wireless device, a Physical Random Access Channel (PRACH) preamble for a first beam corresponding to one of the plurality of SSBs in the SSB burst transmission.

9. The method according to claim 8, wherein the method comprises: determining, based on the PRACH preamble, one or more second beams different than the first beam.

10. The method according to claim 1, wherein transmitting comprises transmitting to the wireless device, control signaling indicative of one or more frequency resources for the one or more second beams to be measured by the wireless device.

11. The method according to claim 1, wherein the control signaling is comprised in one or more of:
a system information message,
an SSB transmission, and
an SSB configuration.

12. The method according to claim 1, wherein transmitting comprises broadcasting the control signaling indicating the first frequency resource and the second frequency resource.

13. A method, performed by a wireless device, for enabling dynamic allocation of one or more Synchronization Signal Blocks (SSB) of a plurality of SSBs, including a first SSB and a second SSB, in an SSB burst received from a network node, the method comprising: receiving, from a network node, control signaling indicating a first frequency resource for the first SSB and a second frequency resource for the second SSB in the SSB burst received from the network node, wherein the first frequency resource and the second frequency resource are different; and measuring at least one SSB of the plurality of SSBs according to the control signaling received.

14. The method according to claim 13, wherein the control signaling is indicative of a respective frequency resource for each of the plurality of SSBs in the SSB burst received from the network node.

15. The method according to claim 13, wherein the control signaling is indicative of a respective time resource for each SSB of the plurality of SSBs in the SSB burst received from the network node.

16. The method according to claim 13, wherein the frequency resource is part of an unlicensed frequency band or of a licensed frequency band being shared by a plurality of operators.

17. The method according to claim 16, wherein the frequency resource is a sub-band of the unlicensed frequency band or the licensed frequency band being shared by a plurality of operators.

18. The method according to claim 13, wherein the method comprises, transmitting, to the network node, a Physical Random Access Channel, PRACH, preamble for a first beam corresponding to one of the measured SSBs.

19. The method according to claim 18, wherein receiving comprises receiving, from the network node, control signaling indicative of one or more frequency resources for one or more second beams different than the first beam, wherein the indicated frequency resource is different than the frequency resource used for the SSB of the first beam.

20. The method according to claim 13, wherein the control signaling is comprised in one or more of:
a system information message,
an SSB transmission, and
an SSB configuration.

21-22. (canceled)
